(19) United States
(12) Patent Application Publication
(10) Pub. No.: US 2008/0103911 A1
(43) Pub. Date: May 1, 2008

(54) APPARATUS AND METHOD OF DATA DEPENDENT ROUTING FOR DATA STORAGE

(75) Inventors: Sumit Singh, Irving, TX (US); Arvind Rajagopalan, Irving, TX (US); Mohammad Lari, Irving, TX (US); Paul Boppuri, Irving, TX (US); Walid Hassan, Irving, TX (US); Javier Martinez, Coppell, TX (US)

Correspondence Address: VERIZON;PATENT MANAGEMENT GROUP, 1515 N. COURTHOUSE ROAD, SUITE 500, ARLINGTON, VA, 22201-2909, US

(73) Assignee: MCI, LLC., Basking Ridge, NJ (US)

(21) Appl. No.: 11/553,967

(22) Filed: Oct. 27, 2006

(51) Int. Cl. G06Q 20/00

(52) U.S. Cl. 705/16

(57) ABSTRACT

An approach is provided for data dependent routing. Sales data including a transaction key is received. One of a plurality of order databases is selected based on the transaction key. The sales data is forwarded to the one order database for storage.

### BACKGROUND INFORMATION

Business organizations require massive data processing and storage systems to handle high volume sales orders and to retain sales information generated from order handling systems. In a high-volume order transaction system with multiple replicable order data storage systems, delays are introduced by extensive computations for balancing the workload on computing resources (e.g., servers). Further, as the workload on any one system exceeds a point at which additional capacity is needed, physical device upgrades are often required.

A conventional approach is to upgrade the system resources—i.e., “scale up.” Under this approach, once capacity thresholds are identified (often without automatic alert), capacity is added to existing servers and/or existing storage systems through hardware upgrade. The drawback with this approach is that during the upgrade process, the system is unavailable.

Therefore, there is a need for an approach for efficiently storing data, while providing high scalability and availability.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of an automated sales order fulfillment system capable of providing data dependent routing, in accordance with an exemplary embodiment;

FIG. 2 is a diagram of the data dependent routing subsystem of the system of FIG. 1, according to an exemplary embodiment;

FIGS. 3A and 3B are flowcharts of processes for data dependent routing, according to various exemplary embodiments;

FIG. 4 is a diagram of system employing a “scale-up” approach to data processing and storage;

FIG. 5 is a diagram of a “scale-out” approach to data storage utilized in the data dependent router of FIG. 2, according to an exemplary embodiment; and

FIG. 6 is a diagram of a computer system that can be used to implement various exemplary embodiments.

### DETAILED DESCRIPTION

An apparatus, method, and software for providing data dependent routing are described. In the following description, for the purposes of explanation, numerous specific details are set forth in order to provide a thorough understanding of the various exemplary embodiments. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

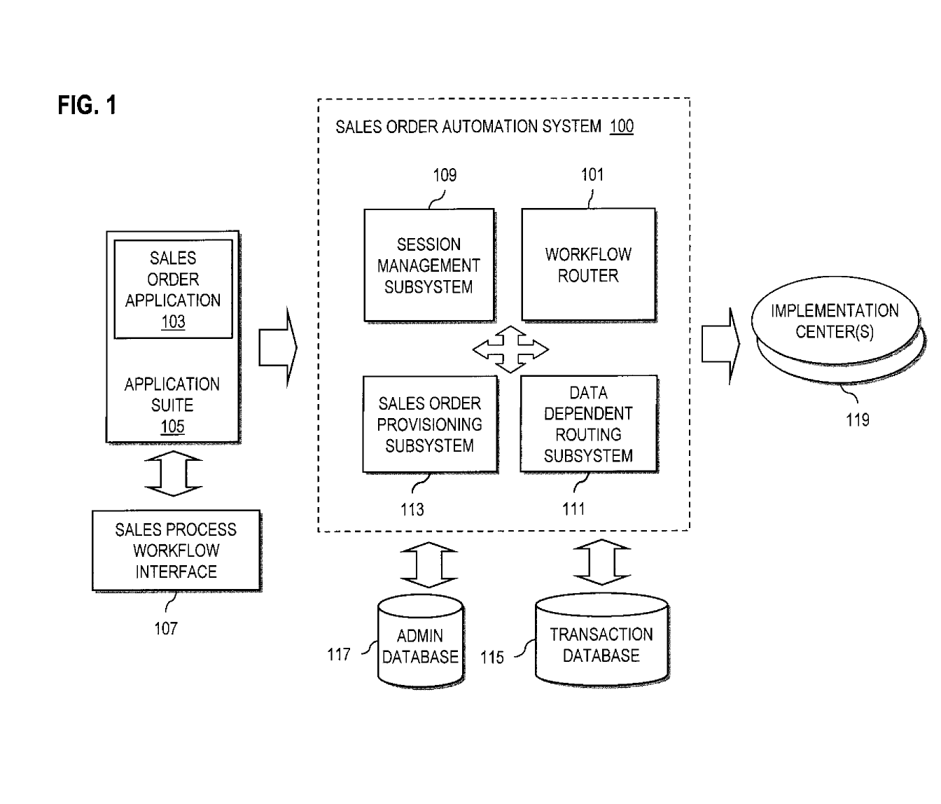

FIG. 1 is a diagram of an automated sales order fulfillment system capable of accurately routing sales orders, in according with an exemplary embodiment. An automated sales force workflow system 100 encompasses a workflow router 101 for distributing sales orders generated from a sales order application 103. The sales order application 103 can be part of an application suite 105 that supports sales and marketing functions, which lead to the fulfillment of sales orders. The application suite 105 can be deployed in multiple sales centers (not shown). A user can interact with the application suite 105 using a sales process workflow interface 107 as a front end presentation screen to utilize any number of sales, marketing, and even accounting applications. At any pint in any application, user-entered data related to a sales order may be collected.

The system 100 may include a session management subsystem 109 to maintain copies of collected data for persistence across applications, to eliminate, for instance, the need for user re-keying of information, thereby more efficiently conducting transactions. The session management subsystem 109 can pre-populate an interface screen with any previously-collected data related to the sales order. Upon completion of the sales order, the session management subsystem 109 can initiate the order implementation process by forwarding the collected sales order data to data dependent routing subsystem 111.

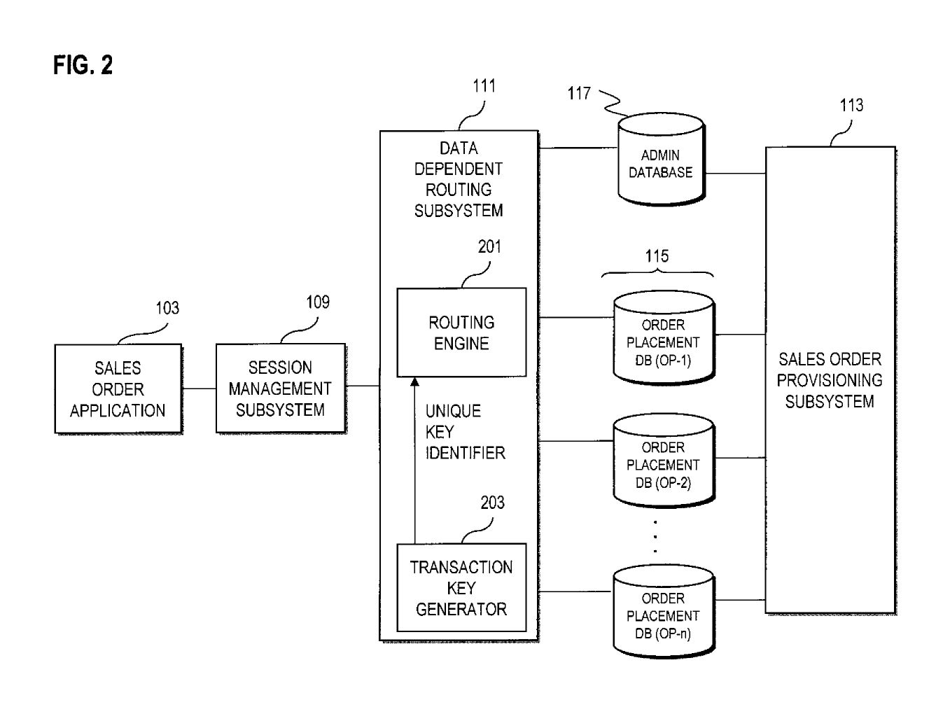

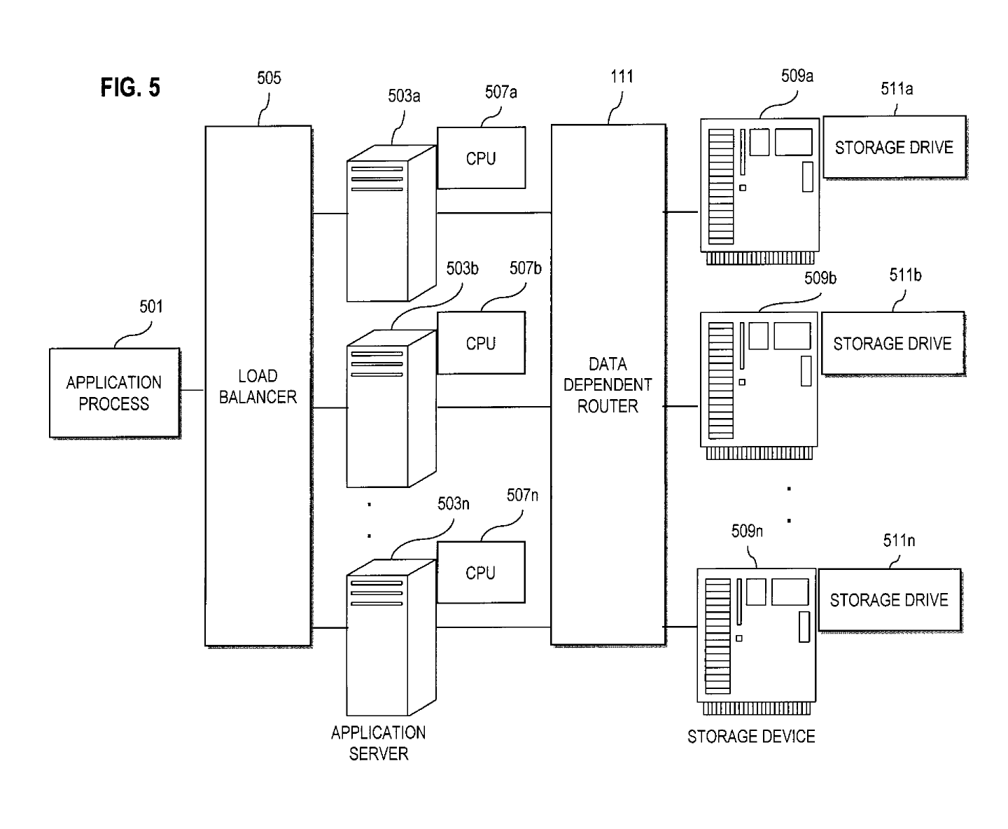

Among other functions, the data dependent routing subsystem 111 may be used to load balance the transfer of data to the system 100. The subsystem 111 communicates via a sales order provisioning system 113 to deposit the collected data in a transaction database 115. Using a “scale-out” approach (as explained below in FIG. 5), the data dependent routing subsystem 111 employs a unique key to partition data to service data queries, which enables load balancing of databases. The components of the subsystem 111 are more fully described in FIG. 2.

An administration database (denotes as “admin database”) 117 is also maintained to store user profile information and other management information about the system 100. In an exemplary embodiment, the admin database 117 can store business rules and criteria necessary of the workflow router 101 to process the sales orders.

As shown, the workflow router 101 communicates with one or more implementation centers 119 to properly route the sales orders based on the business rules. As such, these implementation centers 119 represent multiple end points for completed order handling. Accordingly, the workflow router 101 performs selection decisions as to avoid mistaken identification of available, capable end points and/or lost parts of a multi-item order.

FIG. 2 is a diagram of the data dependent routing subsystem of the system of FIG. 1, according to an exemplary embodiment. By way of example, an order creator uses the sales order application 103 to complete an order. The session management subsystem 109, which is optionally utilized, maintains order data through inter-application navigation; and when the order is complete, passes the information to the data dependent routing subsystem 111.

Under this exemplary scenario, the transaction database 115 encompasses multiple order placement databases (OPs); that is, OP-1 to OP-n. Each of these order placement databases includes transaction tables. The admin database 117 includes user profile tables, admin tables, and a table for unique key identifiers (e.g., a user identification (ID)) utilized for data dependent routing. There is a Unidirectional [Transactional] replication from all of the OPs with the transaction tables to the admin database 117. Whenever a key identifier is generated on one of the order placement databases, the key table is updated for the new entry. Namely, the admin database 117 behaves as a subscriber, while the OPs 115 act as the publishers.

The data dependent routing subsystem 111 includes a data dependent routing engine 201, which balances the load of order allocation to any number of the order placement databases 115. This load balancing capability can be implemented based on various criteria—e.g., utilization, availability, connectivity parameters, etc. The engine 201 utilizes the unique key identifier for partitioning the data, which assists in the load balancing of the databases 115 in serving requests from, for example, web servers (not shown). In an exemplary embodiment, this key identifier is associated with a user; such information can be maintained in the admin database 117 within a user profile.

Traditionally, load balancing techniques employ a separate load monitoring system that queues an incoming job to the storage system. Such approach has the drawback of maintaining state values on each storage system, which requires significant system resources and also is a source of delay. By contrast, the data dependent routing subsystem 111 need not retain state information to effectively load balance.

A transaction key generator 203 produces a unique key value that can be parsed to provide identification of (e.g., a routing “address”) a particular order placement database (e.g., OP-1, OP-2, . . . OP-n). It is noted that although the transaction key generator 203 is shown as a part of the data dependent routing system 111, it is contemplated that this function can reside externally from the data dependent routing system 111, such as the sales order provisioning subsystem 113. In an exemplary embodiment, the parsing is accomplished by a modulus (Mod(x)) operation. The resultant modulus value is mapped to an order placement database. The admin database 117 retains the modulus divisor value, x, as well as a table that maps modulus values to the order placement databases (e.g., remainder 1 is routed to OP-1; remainders 2 and 8 are mapped to OP-2, etc.). It is noted that the value of x can be suitable selected depending on the system design criteria.

For example, a mod 40 operation specifies that every key identifier that is generated on the OPs has an increment of 40 and the seed value used in each OP is different, as illustrated in Table 1.

TABLE 1
OP 1: Seed Value used is 1 and the next One Source ID generated is
1 + 40 = 41, 81, 121 ...
OP 2: Seed Value is 2 and the next One Source ID generated is
2 + 40 = 42, 82, 122 ...

This provides the system 111 the flexibility to scale out to 40 OP nodes. The requests for routing based on the key IDs is shown in Table 2:

TABLE 2
If Mod(Key ID #1) = 1 then the request is routed to OP1
If Mod(Key ID #2) = 2 then the request is routed to OP2 and so on.

A number of processes are available to supply the mapped value to data dependent router 203, while maintaining an option to modify the values without restarting the system. According to one embodiment of the present invention, such values are loaded into memory by data dependent router 203 and updated periodically through a request to the admin database 117. Any value may be used as the divisor for the modulus operation; so long as the modulus divisor is greater than the number of order placement databases 115, there is no subsequent decision.

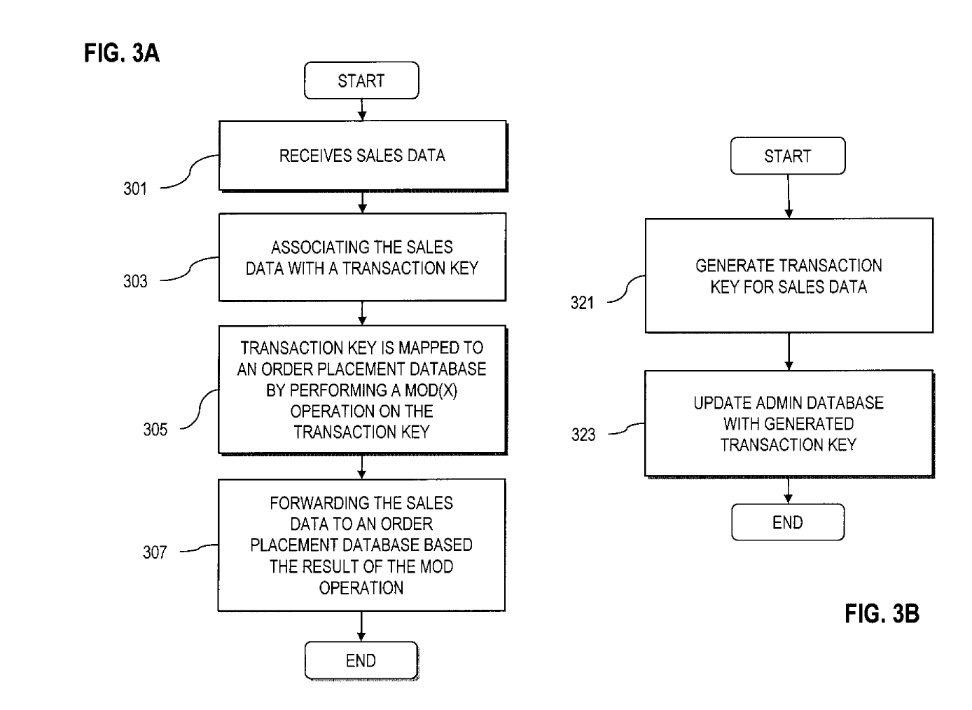

Upon parsing of unique key value, the data dependent routing engine 201 routes it and order information to the mapped order placement database, and a subset of that record to the admin database 117. This operation is further explained below with respect to FIG. 3.

When sales order provisioning system 131 is subsequently invoked, such invocation can be independent of this process flow or made by any of the components in the flow upon recognition that the order data are stored.

FIGS. 3A and 3B are flowcharts of processes for data dependent routing, according to various exemplary embodiments. Initially, the sales order application 103 either invokes the data dependent routing engine 201 directly, or optionally, via the session management subsystem 109. The order or sales data is either passed directly to data dependent routing engine 201 or is referenced by a pointer (per step 301). In step 303, the sales data is associated with a unique key identifier (e.g., transaction key). The unique key identifier is then mapped to a particular order placement database 115 (step 305), using according to an exemplary embodiment, the modulus operation. For example, the key may be mapped to OP-1.

Next, as in step 307, the data dependent routing engine 201 writes the sales data (e.g., complete order data) to OP-1. The unique key identifier and a subset of the transaction data are also written to the admin database 117. The unique key identifier and the complete transaction details are stored in the mapped order placement database (e.g., OP-1).

As shown in FIG. 3B, a capability exists within the data dependent routing subsystem 111 to generate transaction keys. For example, the data dependent routing engine 201 can invoke the transaction key generator 203 (of FIG. 2) to output a unique key identifier (e.g., transaction key), per step 321. It is contemplated that this process of generating transaction keys can occur in a component or process that is external to the subsystem 111. The newly generated transaction key is then updated within the admin database 117 (step 323).

As described previously, this replication to admin database 115 may be accomplished in a number of ways. In one embodiment, the data dependent routing subsystem 111 performs this replication. Alternatively, replication to the admin database 117 is accomplished by standard storage area network functions.

To better appreciate the data dependent routing mechanism for addressing data storage and associated scalability issues, it is instructive to examine the traditional “scale-up” approach, as next explained.

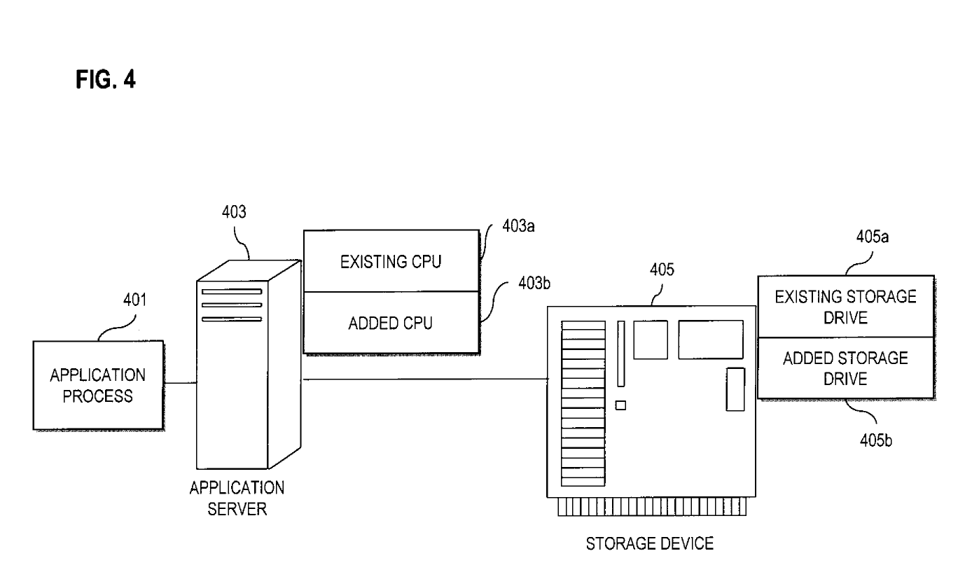

FIG. 4 is a diagram of system employing a “scale-up” approach to data processing and storage. In a scale-up method, an application process 401 connects to application server 403, which includes an existing central processor unit (CPU) 403a power to process an order transaction and write the order information to storage device 405. The storage device 405 employs an existing storage drive 405a. The following capacity issues are posed: (1) the number of jobs to be processed through the application server 403 results in processing delays because of inadequate CPU capacity; and/or (2) the existing storage driver 405a reaches a capacity threshold, whereby no further orders should be written to it.

In the first case, a new CPU 403b is added to the application server 403 to accommodate the higher transaction volume. However, the upgrade generally requires the server 403 to be down or unavailable. While some hardware solutions allow “hot” upgrade capabilities that can be accomplished without suspending the availability of the application server 403, such approaches are expensive in terms of downtime and are constrained by how much upgrading can be performed.

Similar constraints exists with the second case, in that the added storage driver 405b, even in a hot upgrade scenario, still may require temporary unavailability of the entire storage system 405 to add a partition configuration for the added storage.

Thus, scalability can be achieved thorough symmetric multiprocessing (SMP) scale up—by adding more processors, memory, disks, and network cards to a single node (e.g., server, etc.). However, with certain class of applications where a node reaches its capacity limitation and cannot grow any further, the scale up approach is not suitable. Each connection and request requires CPU, memory, disk and network resources, which can only scale so far on a single system.

By contrast, a different, scalable approach is adopted by the system 100 of FIG. 1, as described in FIG. 5.

FIG. 5 is a diagram of a “scale-out” approach to data storage utilized in the data dependent router of FIG. 2, according to an exemplary embodiment. Under this scenario, prior to needing to add capacity, the application process 501 communicates with any of a number of application servers 503 via a selection made by a load balancer 505. Each server 503a-503n has a CPU 507a-507n, respectively. The selected server communicates a job request to the data dependent router 111, which routes the order to existing storage devices 509a-509n, with corresponding storage driver 511a-511n.

When server capacity thresholds are reached, an application server with CPU can be added. When the physical aspects of the server addition is complete, the tables that drive the decisions of the load balancer 505 are updated so that it is able to “see” that application server is now available for accepting jobs. In this manner, server capacity constraints are eased with no requirement to suspend any of the current server capacity.

Similarly, when storage capacity thresholds are reached, another storage device with storage drive can be added. When more capacity is required, a table can be updated to acknowledge the presence of the added storage device. As previously described with respect to FIG. 2, the prior-to-addition values are loaded into memory by the data dependent router 111 and updated through a periodical check via request to the admin database 117. Therefore, the data dependent router 111 is never suspended through the upgrade process. The router 111 is thus made aware of the new storage device for writing orders immediately upon its availability, such that no portion of the storage writing capacity is suspended at any time.

Finally, with respect to the case where a specific storage device becomes unavailable through its own error condition, the dependent data router 111 can correct the situation automatically. According to an exemplary embodiment, the data dependent router 111 may detect a delay that is too lengthy (e.g., via a timeout mechanism) for communicating an order to the storage device. In this case, the router 111 can initiate a direct change to the admin database 117, or to its in-memory copy, to change the routing for that modulus value to a different storage device.

Alternatively, another monitoring system can continually test the availability of the many storage devices and update the admin database 117 accordingly. The data dependent router 111 can uncover the situation in its next periodic check of modulus-to-storage device mapping.

Although the scale-out approach is explained with respect to CPU and storage devices, it is recognized that this approach has applicability to any type of network or system resources. With the above scale-out approach, organizations can cluster inexpensive systems to achieve high levels of availability and reliability, resulting is an overall lower cost.

The above described processes relating to access control may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

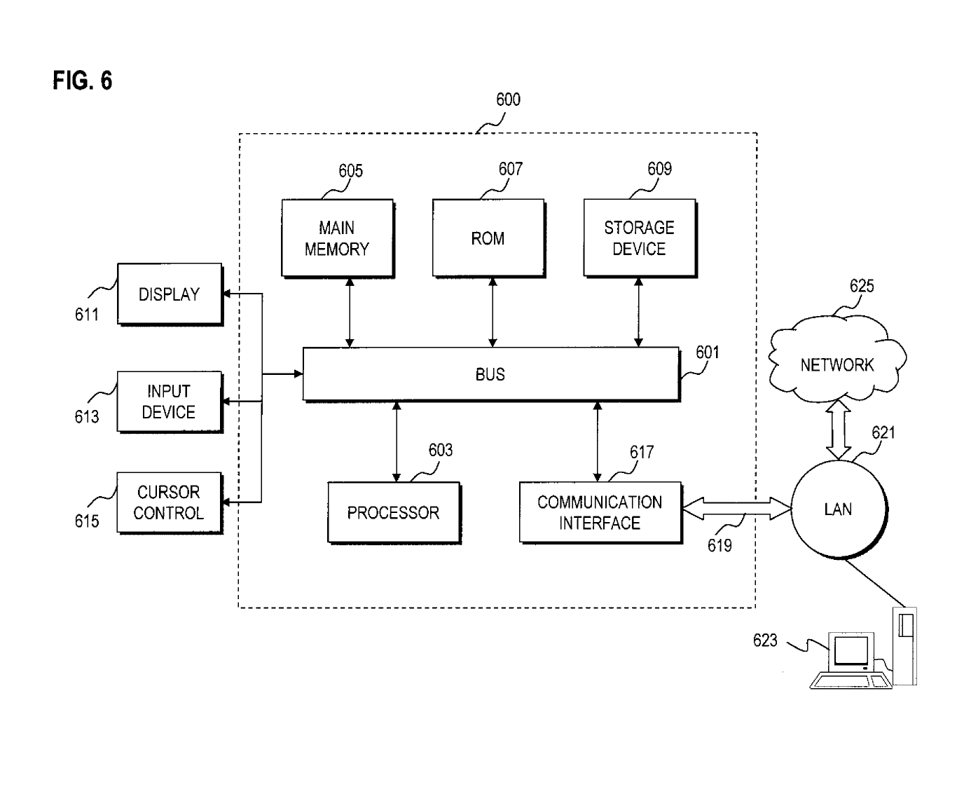

FIG. 6 illustrates a computer system 600 upon which an exemplary embodiment can be implemented. For example, the processes described herein can be implemented using the computer system 600. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an exemplary embodiment, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the exemplary embodiment. Thus, exemplary embodiments are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an exemplary embodiment through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of various embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
receiving sales data associated with a transaction key;
selecting one of a plurality of order databases based on the transaction key; and
forwarding the sales data to the one order database for storage.

2. A method according to claim 1, wherein the transaction key is mapped to a user of a sales order system, the sales order system being configured to process the sales data.

3. A method according to claim 1, wherein the one order database is selected by performing a modulus operation on the transaction key to output information for identifying the one order database.

4. A method according to claim 3, wherein parameters of the modulus operation is maintained in an administration database separate from the order databases.

5. A method according to claim 1, wherein the transaction key is maintained in an administration database separate from the order databases, the method further comprising:
generating a new transaction key for inclusion in another set of sales data; and
updating the administration database for the new transaction key.

6. A method according to claim 1, wherein the selection of the one order database is based on a load balancing criterion.

7. A method according to claim 1, further comprising:
receiving a request for sales data stored in one of the order databases, wherein the request specifies the transaction key; and
retrieving the requested sales data from the one order database according to the transaction key.

8. An apparatus comprising:
a processor configured to receive sales data associated with a transaction key, and to select one of a plurality of order databases based on the transaction key,
wherein the sales data is forwarded to the one order database for storage.

9. An apparatus according to claim 8, wherein the transaction key is mapped to a user of a sales order system, the sales order system being configured to process the sales data.

10. An apparatus according to claim 8, wherein the one order database is selected by performing a modulus operation on the transaction key to output information for identifying the one order database.

11. An apparatus according to claim 10, wherein parameters of the modulus operation is maintained in an administration database separate from the order databases.

12. An apparatus according to claim 8, wherein the transaction key is maintained in an administration database separate from the order databases, and the processor is further configured to generate a new transaction key for inclusion in another set of sales data, wherein the administration database is updated with the new transaction key.

13. An apparatus according to claim 8, wherein the selection of the one order database is based on a load balancing criterion.

14. An apparatus according to claim 8, wherein the processor is further configured to receive a request for sales data stored in one of the order databases, wherein the request specifies the transaction key and the requested sales data is retrieved from the one order database according to the transaction key.

15. A system comprising:
a data dependent routing system configured to receive sales data associated with a transaction key; and
a plurality of order databases coupled to the data dependent routing system,
wherein the data dependent routing system is further configured to select one of the order databases based on the transaction key, and the received sales data is stored in the selected order database.

16. A system according to claim 15, wherein the transaction key is mapped to a user of a sales order system, the sales order system being configured to process the sales data.

17. A system according to claim 15, wherein the one order database is selected by performing a modulus operation on the transaction key to output information for identifying the one order database.

18. A system according to claim 17, wherein parameters of the modulus operation is maintained in an administration database separate from the order databases.

19. A system according to claim 15, further comprising:
an administration database configured to store the transaction key, wherein the data dependent routing system is further configured to generate a new transaction key for inclusion in another set of sales data, the new transaction key being updated in the administration database.

20. A system according to claim 15, wherein the selection of the one order database is based on a load balancing criterion.

21. A system according to claim 15, wherein the data dependent routing system is further configured to receive a request for sales data stored in one of the order databases, wherein the request specifies the transaction key and the requested sales data is retrieved from the one order database according to the transaction key.
